(19) United States
(12) Patent Application Publication
(10) Pub. No.: US 2007/0131892 A1
(43) Pub. Date: Jun. 14, 2007

(54) Stain repellant and release fabric conditioner

(76) Inventors: Dominick J. Valenti, Greenville, SC (US); Diana C. Balasca, Simpsonville, SC (US); Xinggao Fang, Duncan, SC (US); Emily W. Michaels, Greenville, SC (US); Eduardo Torres, Boiling Springs, SC (US); Brian D. Walton, Boiling Springs, SC (US)

Correspondence Address: Cheryl J. Brickey;Milliken & Company, Legal Department, M-495, P.O. Box 1926, Spartanburg, SC, 29304, US

(21) Appl. No.: 11/590,614

(22) Filed: Oct. 31, 2006

Related U.S. Application Data
(60) Provisional application No. 60/749,388, filed on Dec. 12, 2005.

(51) Int. Cl. D06M 15/263; D06M 13/224; B32B 27/04; D06M 15/643; B05D 3/00; B05D 3/02

(52) U.S. Cl. 252/8.61; 252/8.62; 252/8.63; 427/299; 427/393.4; 442/93; 442/94

(57) ABSTRACT

The invention relates to a stain release and repellant fabric conditioner comprising a repel type fluorochemical and/or siloxane, a release type fluorochemical and/or siloxane, and a performance extender.

### CROSS-REFERENCE TO RELATED APPLICATIONS

This application claims the benefit of and priority from United States Provisional Application 60/749,388, filed on Dec. 12, 2005, the contents of which are hereby incorporated by reference in their entirety as if fully set forth herein.

### TECHNICAL FIELD

The present invention generally relates to a stain repel and release agent. More particularly, the invention relates to a stain repel and release agent applied to fabrics with a fabric conditioner.

### BACKGROUND

Soil release agents are key ingredients in cleaning, e.g., textile laundry and hard surface such as carpet-cleaning; and textile treating. Durable soil release agents are commonly applied during manufacture of clothing or textile fiber. Other non durable methods of treatment may include the incorporation within laundry detergents. The primary purpose of the soil release agents is to make it easier to clean the textile fibers by home cleaning methods using conventional household machines or cleaners.

For example, in laundering processes normally employed, such as washing in a conventional home washing machine or hand washing with detergent bars, it is usually very difficult to remove soil and/or oily stains from textile material. Moreover, assuming that the undesirable materials are removed from the textile and/or a fairly clean textile material is being washed, soil remaining in the wash water is often redeposited onto the textile material prior to the end of the wash cycle. Hence, when the textile material is removed from the washing machine and subsequently dried, it has not been properly cleaned. Thus, textile material after use rarely assumes a truly clean appearance, but instead tends to gray and/or yellow due to the soil and/or oily materials deposited or redeposited and remaining thereon.

Consumers desire to protect their fine textile and fabric-based products from excessive dirt, wear, and moisture. Thus, compositions or treatments methods that may be applied to consumer articles or fabrics to repel dirt or moisture, or to preserve the appearance of such articles, are highly desirable.

Siloxanes are known as water repellents for textile and hard surfaces. However, many of these compositions do not work well on cotton or polycotton fibers, and do not exhaust well in the laundry cycle. They may require large doses in order to cover the fabric due to their inefficient exhaustion on textiles. Several companies produce siloxanes for potential use as water repellants or soil releasing agents.

Aftermarket products sold for adding repellency may be provided as an aerosol application. Some examples of such products include: Scotchgard® brand products, Kiwi Camp Dri®, Rivivex™ (which includes a curing step in the dryer), Blue Magic Tectron Wet Guard™, and Nikwax TX™. These products are marketed primarily as water repellants and soil repellents to provide or restore repellency on outerwear or shoes. They may be delivered via a solvent or water dispersion aerosol.

A minority of aftermarket products are marketed using a wash-in application. These include Nikwax TX™, which provides for a direct wash-application for the restoration of a durable water-repellency) and Storm Proofer Plus “Rudolf”™, a stain and abrasion resistant finish based on a water dispersed hydrocarbon. ReviveX Wash-in™ water repellent is suggested for use with outerwear, and Granger wash-in waterproofing is provided for restoring repellency to a factory applied finish.

### DETAILED DESCRIPTION OF THE INVENTION

It is one object of the current invention to provide novel compositions and methods of use that impart oil repellency, water repellency, stain resistance, and stain release properties simultaneously to a substrate.

“Water repellency” and “oil repellency” are generally defined as the ability of a substrate to block water and oil from penetrating into the substrate. This is accomplished by the preventing of said liquids from wetting or spreading on the substrate. The liquids, therefore, will not have the opportunity for significant absorption and substantively (staining). The high contact angle liquids can roll or be brushed off. For example, the substrate may be a textile substrate which is capable of blocking water and oil from penetrating into the fibers of the textile substrate forming a non-absorbed liquid bead that can be brushed off.

“Stain release” generally is defined as the degree to which a stained substrate approaches its original, unstained appearance as a result of a care procedure. As defined herein, high levels of stain resistance means an oil repellency rating of at least 3.0 when tested by AATCC Test Method 118-2000, a water repellency rating of at least 1.0 when tested by the 3M Water Repellency Test II (May, 1992). Acceptable stain release, as described herein, means a rating for corn oil and mineral oil release of at least 3.0 when tested by AATCC Test Method 130-2000.

The terms “fluorocarbons,” “fluoropolymers,” and “fluorochemicals” may be used interchangeably herein and each represents a polymeric material containing at least one fluorinated segment. A Fluorochemical is defined as an organic molecule (to include oligomers, polymers and dendritic structures) which contain significant Fluorine substituents (between 4-30% based on solids) so as to lower their surface tension (neat or in a water dispersion) below 30 mN/m.

Various fluorochemicals have been developed for application to fabrics to impart water and oil repellency (as well as soil resistance) thereto. These fluoropolymers may be referred to as repel type fluorochemicals. Potentially preferred, non-limiting, compounds of this type include REPEARL® F8025 and REPEARL® F-89, both available from Mitsubishi Corp., as well as ZONYL® 7713, available from DuPont. Treatment of a substrate with a hydrophobic stain repellency agent (repel type fluorochemical) generally results in a surface that exhibits a low surface energy. Other preferred repel type fluorochemicals include fluorinated acrylates, fluorinated urethanes, and fluorinated dendrimers that are typical to the textile finishing industry.

Preferably, the repel type fluorochemical composition used in preparing the water- and oil-repellent composition of the invention comprises a water dispersable film forming polymer that has available CF₃ groups at the air substrate interface. The selected composition must also be capable of curing (structurally reorganize) in order to achieve the thermodynamically preferred surface conformation (R_{f})'s at the interface). Thus, the fluorochemical composition can be comprised of any water or fabric conditioner dispersible CF3 polymer that,
1.) will significantly deposit onto the fabric surface (deposition) vs. remaining in the rinse solution.
2) thermodynamically rearrange under consumer conditions, and
3.) not impart any negative sensory effects to the substrate.

In another embodiment, repel type fluorochemical agents useful in this invention comprise fluorochemical compounds or polymers containing one or more fluoroaliphatic groups R_{f}, which are fluorinated, stable, inert, non-polar, preferably saturated, monovalent and both oleophobic and hydrophobic. R_{f} preferably contains at least about 3 carbon atoms, more preferably 3 to about 20 carbon atoms, and most preferably about 4 to about 14 carbon atoms. R_{f} can contain straight chain, branched chain, or cyclic fluorinated alkylene groups or combinations thereof or combinations thereof with straight chain, branched chain, or cyclic alkylene groups. R_{f} is preferably free of polymerizable olefinic unsaturation and can optionally contain catenary heteroatoms such as oxygen, divalent or hexavalent sulfur, or nitrogen. It is preferred that R_{f} contain about 40% to about 78% fluorine by weight, more preferably about 50% to about 78% fluorine by weight. The terminal portion of the R_{f} group contains a fully fluorinated terminal group. This terminal group preferably contains at least 7 fluorine atoms, e.g., CF₃ CF₂ CF₂—, (CF₃)₂ CF—, —CF₂ SF₅, or the like. Perfluorinated aliphatic groups (i.e., those of the formula CₙF₂ₙ₊₁) are the most preferred embodiments of R_{f}.

Examples of repel type fluorochemical agents include, for example, R_{f}-containing urethanes, ureas, esters, amines (and salts thereof, amides, acids (and salts thereof), carbodiimides, guanidines, allophanates, biurets, and compounds containing two or more of these groups, as well as mixtures and blends thereof.

Preferably, the repel type fluorochemical has a melting temperature of between 25 and 100 degrees Celsius. It has been found that fluorochemicals in this range increase in repel characteristics when dried in a consumer dryer. It is believed that the performance increases because the fluorochemicals go above their melting temperatures (Tₘ) and are able to reconfigure to better produce a repel type surface (low surface energy thermodynamically preferred interface).

Stain release agents help stains come out of fabrics. Fluorinated stain release agents (release type fluorochemicals) can be described as those that mitigate the rolling out or wetting of a liquid stain and the adhesion of a solid stain during soiling contact, while maintaining wettability of the fabric with aqueous surfactant during the cleaning cycle. Hydrophilic comonomer containing fluorinated stain release polymers are the preferred stain release type fluorochemical with a hybrid dual functionality. Potentially preferred, non-limiting, compounds of this type include UNIDYNE® TG-992, available from Daikin Corp., REPEARL® SR100, available from Mitsubishi Corp., as well as ZONYL® 7910, available from DuPont. Treatment of a substrate with a hybrid stain release type fluorochemical generally results in a surface that exhibits a higher surface energy during cleaning conditions (aqueous) and a lower surface energy during non-aqueous environments (switchable). Preferred release type fluorochemicals include hybrid dual function fluoropolymers and C4 type polymers available from 3M.

Preferably, the release type fluorochemical has a melting temperature of between 25 and 100 degrees Celsius. It has been found that fluorochemicals in this range increase in release characteristics when dried in a consumer dryer. It is believed that the performance increases because the fluorochemicals go above their melting temperatures and are able to reconfigure to the most thermodynamically stable surface (lower energy at the surface) to better produce a release or repel type surface.

The repel type fluorochemicals and the release type chemicals may be used separately, but preferably used together. This gives fabrics stain repellency and release in one step. The repel type fluorochemicals and the release type fluorochemicals are used with a performance extender, such as fabric conditioner. If the fluorochemicals are used without a performance extender, much more fluorochemical is needed which decreases the efficiency of use and therefore increases the cost per wash to the consumer. Soaking time (in the rinse) and drying time do not appear to affect the performance of the fluorochemicals.

Preferably, the stain release and repellant fabric conditioner is added to the rinse cycle in an amount such that the total fluorochemicals by active weight are greater than 0.03% by weight of the fabric, more preferably, 0.06 to 2.0% when used with performance extender, and preferably 0.35 to 0.65% as a stand alone additive. The rinse cycle preferably has a temperature of greater than 15 degrees Celsius, more preferably a temperature between 20 and 40 degrees Celsius. It has been found that in this range both repel and release characteristics are maximized.

A performance extender is used allowing the use of less fluorochemicals with the same benefits and while not bound to theory, the Applicants believe that the performance extender helps level the fluorochemical onto the substrate, while also co-depositing a non-polar (hydrophobic) group onto the surface, filling the sites between the fluorochemical deposited onto the fabric. The term “fluoropolymer extender” as used herein is to be understood to mean non-fluorine containing surfactants or paraffins which improve the wetting characteristics of the textile material and thereby enhance the application of the fluoropolymer to the textile material. Any suitable surfactant which is compatible with the fluoropolymer and the textile material and which will improve the wetting characteristics of the textile material can be employed. Such surfactants can be cationic, anionic, non-ionic, or amphoteric in nature. Especially desirable results can be obtained when the surfactants are cationic (such as quaternary ammonium compounds etc.) or non-ionic in character. We also refer to fluoropolymer extenders these compounds as performance extenders.

Typical examples of fluoropolymer extenders meeting the above criteria are nonionic C₃-C₁₅ alcohols, including linear, non-linear, saturated and unsaturated, such as isopropanol, 1-dodecanol, 2-ethylhexanol, allyl alcohol; cationic surfactants, such as cationic polyethylene, 1-dodecyltrimethyl ammonium chloride; fatty alcohols such as 1-octadecanol, 1-hexadecanol and the like; anionic surfactants, such as sodium lauryl sulfate, dodecyl sulfosuccinate, dodecyloxy poly (oxyethyl) sulfosuccinate, alkyl phosphates and the like; non-ionic surfactants; amphoteric surfactants; ethylene copolymers; fatty glycerides, such as glycerol trioleate, castor oil and the like.

Useful extender compounds also include, for example, siloxanes, (meth)acrylate and substituted acrylate polymers and copolymers, N-methylolacrylamide-containing acrylate polymers, urethanes, blocked isocyanate-containing polymers and oligomers, condensates or precondensates of urea or melamine with formaldehyde, glyoxal resins, condensates of fatty acids with melamine or urea derivatives, condensates of fatty acids with polyamides and their epichlorohydrin adducts, waxes, polyethylene, chlorinated polyethylene, alkyl ketene dimers, esters, and amides, and mixtures thereof. Most preferred are quaternary ammonium salts that are typically a main component in fabric conditioners.

It has long been recognized that certain chemical compounds have the capability of imparting softness to textile fabrics. These compounds, which are known generally as “softening agents”, “fabric softeners”, or “softeners”, have been used both by the textile industry and by home and industrial laundry processors to soften finished fabrics, thereby making them smooth, pliable and fluffy to handle. In addition to the quality of softness, the fabrics have a reduced tendency to static cling and are easier to iron.

The fabric conditioner in the soil release fabric conditioner may be any known fabric conditioning chemistry. The large majority of home laundering agents available on the market today under the name of softeners are compositions based on quaternary ammonium salts containing two long-chain alkyl groups within the molecule, such as bis(hydrogenated tallow alkyl) dimethylammonium chloride, for instance. This is because quaternary ammonium salts produce satisfactory softening effects on various fibers even when used in small quantities.

In other fabric conditioning compositions, non-ester-linked quaternary ammonium fabric softening agents have been used although there is a trend away from such compounds to ester-linked quaternary ammonium fabric softening agents. It is desirable to use ester-linked compounds due to their inherent biodegradability. Such ester-linked quaternary ammonium compounds contain hydrocarbyl chains which can be unsaturated, partially hardened or fully saturated.

The combination of a fabric conditioner and the repel/release chemicals during the laundry rinse cycle (via fabric softener etc.) enhances the soil release properties, as well as abrasion durability, to the textile without adversely affecting the aesthetic value or hand of the textile. However, if too much fabric softener (or performance extender) is added, the repel/release characteristics can start to diminish. These theories also hold true for the siloxanes and others.

In another embodiment, the stain release and repellant fabric conditioner is a propoxylated hydroxyl- or amino-polysiloxane and a performance extender. A mixture of 1 part siloxane (EAF1540-Wacker Chemicals, this procedure works for any aminosiloxane or silanol), 2 parts diethyl malonate (Aldrich Chemicals) (malonic acid, or any bis-carboxylic acid will also work), 5 parts of a tallow based quaternary ammonium compound (Degussa, any water soluble quat. will work, biodegradable ones are preferred).

A second new siloxane composition was formed by reacting an amino siloxane with a fatty acid derived chain. The fatty chain is preferably derived from lauroyl, stearoyl, tallowoyl, or other common reactive fatty acids with lengths between C8 and C18.

To 1 mol of Amine-G (Lambent, any aminosiloxane or silanol will work) is added 1.1 mol of lauryol chloride (Aldrich Chemicals, Any C12 or higher reactive acid will have same effect, eg stearoyl chloride) and the mixture is warmed up to 80° C. for 4 hours. Nitrogen is blown thru to remove any HCl that has been formed. The product can be used with no further processing.

The new siloxane formulation enhances the exhaustion and adherence of the siloxanes and performance extenders onto the textile giving the textile water and soil release properties without adversely affecting the hand.

These new siloxane based compositions can be directly added to a fabric softener at 6-8% by weight of the fabric conditioner or formulated into a new system. The siloxanes may also be an ironing aid when applied to dry fabric at an approximate amount of 0.2% by weight of the fabric.

Preferably, the stain release fabric conditioner is added as a fabric conditioner would be during a wash cycle. The laundry would be loaded into a laundry machine and detergent would be added. The rinse additive is then applied during the rinse cycle of the wash. Various methods such as direct application, through a ball (fabric softener ball that releases its contents during the rinse cycle), or through the machine can be employed. Then the water would be removed from the fabric, preferably through use of added heat. This can be accomplished by air drying, machine drying, or ironing the fabric. Preferably, the laundered materials are then dried in a standard consumer tumble dryer. The treatment is non-durable and can be renewed in successive laundering cycles.

Test Methods

### Stain Application

Samples were tested according to the Oily Stain Release Method AATCC 130-2000 with the variation that the samples were visually assessed and given a ranking of 1 to 5 (1 being the worst and 5 being the best) with 0.5 increments. A description of the staining and washing methods following AATCC 130-2000 is as follows:

For oily stains, a flat surface was covered with aluminum foil and 2 layers of “Scott” paper towels (one-ply sheets #01482). Next, using small droplet bottles, 5 drops of oil were dropped in the same location, and then covered with wax paper and a 5 lb weight for 1 minute. The samples were then hung to dry. The oils used were Mazola Corn Oil (# MZ-05820-LF-04), Finnast Mineral Oil Heavy (# NDC 49580-0600-1), and Burned Motor Oil (BMO).

For food stains a flat surface was covered with aluminum foil and 2 layers of “Scott” paper towels (one-ply sheets #01482). Next, a 1.25 inches (approx. 3.2 cm) diameter stain was applied using the back of a regular plastic pipette. The samples were then hung to dry. The foods used were Kraft Mustard (#014-5602-022), Hunt's Ketchup (#38184-BFA 60325), and coffee (Folgers Dark Roast™).

The fabric size used in each test was between 11 by 7 (27.9 by 17.8 cm) inches to 11 by 13 inches (27.9 by 33.0 cm). The fabric used were from 100% cotton Hanes t-shirts that were each pre-washed with Tide liquid detergent.

### Washing Procedure

All washing was done in a standard consumer washer machine on the large load setting. The machine used 20-22 gallons water (76 L-83 L), 4 lb fabrics (1.82 Kg fabrics), 128 g Tide liquid detergent, and 46 g Downy fabric softener. The washing temperature was set at warm, 105° F.±5° F. (40° C.±3° C.) and the rinse temperature was set at cold, 77° F. (20-25° C.). The washing time included approximately 20 minutes of washing and spin cycles and 20 minutes of rinse and spin cycles. In order to reduce performance variations, controls and samples are done using the same machine, detergent, fabric conditioner etc. at around the same time period. This variation can be realized by examining control fabric results over large periods of time.

The samples were dried in a standard consumer dryer at the high temperature (cotton high, 180° F. or 82° C.) setting for 40 minutes. All t-shirts (samples) were pre-washed with Tide detergent (4 lb large loading) and rinsed with water and no fabric softener before using for the examples.

### Transport Test Procedure

Treated and dried fabric (5×5 inches) were placed over a 180 ml beaker and fixed tightly with a rubber band. 5 drops of deionized water were placed in five separate locations on the fabric. Time was measured in seconds until a zero contact angle was obtained. The total average and standard deviation in seconds were reported.

The following examples illustrate the practice of this invention. They are not intended to be exhaustive of all possible variations of the invention. Parts and percentages are by weight unless otherwise indicated. All percentages are by weight unless otherwise specified.

### EXAMPLES

The compositions of the examples are found below; the invention samples state the percent composition of the fluorochemicals considered without the fabric softener.

CHART 1
Compositions of examples

| Sample | Composition | Manufacturer |
|---|---|---|
| Control 1 | 100% Downy | Proctor and Gamble |
| Invention A | 50% TG-992, 50% Zonyl 7713 | Daiken, DuPont |
| Invention B | 50% TG-992, 50% BK96 | Daiken, Mitsubishi |
| Invention C | 33.3% TG-992, 66.6% Zonyl 7713 | Daiken, DuPont |
| Invention D | 50% TG-992, 50% PD-92 | Daiken, Milliken |
| Invention E | 66.6% TG-992, 33.3% Zonyl 7713 | Daiken, DuPont |
| Invention H | 66.6% PM-490, 33.3% PM-930 | 3M, 3M |

In addition to Downy, Adogen 442, Gain fabric softener, and other performance extenders were tested with similar results.

### Effect of Stain Release and Repel Chemical

The applications of non-durable repel and release properties in the rinse cycle can be realized by the addition of one or the combinations of two repel and release agents. The next chart shows that the combination of agents is important, as is the ratios of the components.

Each sample was tested three times, the sample was first run though the washing cycle and had a treatment applied, then was stained and washed again to test stain release and these results are labeled “1”. This process was repeated an additional two times, labeled “2” and “3”. Each of the samples were added (as received) such that the repel and release chemistries equaled 9% by weight of the fabric softener.

CHART 2
Stain release results for repel and release fluorochemicals

| | | | | Food | Min | Corn | | Oil | |
|---|---|---|---|---|---|---|---|---|---|
| | Ketchup | Mustard | Coffee | Total | oil | oil | BMO | Total | Total |
| Cont. 1 | 2.5 | 1.5 | 5 | 9 | 3.5 | 3 | 2.5 | 9 | 18 |
| Cont. 2 | 4 | 3 | 5 | 12 | 1.5 | 2.5 | 1 | 5 | 17 |
| Cont. 3 | 3.5 | 1.5 | 5 | 10 | 1.5 | 2.5 | 1.5 | 5.5 | 15.5 |
| Inv. A1 | 4 | 3 | 5 | 12 | 2 | 4 | 2 | 8 | 20 |
| Inv. A2 | 3 | 1.5 | 5 | 9.5 | 4 | 4 | 2.5 | 10.5 | 20 |
| Inv. A3 | 3.5 | 2 | 5 | 10.5 | 4.5 | 4 | 3 | 11.5 | 22 |
| Inv. C1 | 4.5 | 1.5 | 5 | 11 | 5 | 5 | 1.5 | 11.5 | 22.5 |
| Inv. C2 | 2.5 | 1.5 | 4 | 8 | 2.5 | 3.5 | 1.5 | 7.5 | 15.5 |
| Inv. C3 | 3 | 1.5 | 4 | 8.5 | 2.5 | 3.5 | 2.5 | 8.5 | 17 |
| Inv. E1 | 3.5 | 2.5 | 5 | 11 | 3.5 | 3 | 3 | 9.5 | 20.5 |
| Inv. E2 | 4 | 2 | 5 | 11 | 4 | 5 | 3 | 12 | 23 |
| Inv. E3 | 2.5 | 2.5 | 5 | 10 | 4.5 | 4.5 | 3.5 | 12.5 | 22.5 |

As can be seen from the chart above, the combination of a repel type fluorochemical and a release type fluorochemical results in excellent (greater than control) stain release in both oil and food stains. Different combinations of repel and release fluorochemicals and different ratios produce different repel and release characteristics. This is done to take advantage of each fluorochemical's intrinsic efficiency as well as each individual compounds propensity to deposit during laundry conditions. The resulting target deposition would be one that is balanced with just enough repel while not hindering release performance. The inventions in Chart 2 demonstrates this.

CHART 3
Stain release results for stand alone release agents in Downy

| | % by weight | | Min | | |
|---|---|---|---|---|---|
| Release Agents | in Downy | Mustard | oil | BMO | Total |
| LUBRIL QCX - | 30 | 1 | 2 | 1.5 | 4.5 |
| Resolution | | | | | |
| Millitex PD75 - | 30 | 1 | 3.5 | 2 | 6.5 |
| Milliken | | | | | |
| TG-992 - Daiken | 10 | 1.5 | 2.5 | 2 | 6 |
| PM-490 - 3M | 10 | 1.5 | 3 | 2.5 | 7 |
| Repearl SR 1450 - | 10 | 1.5 | 2 | 2 | 5.5 |
| Mitsubishi | | | | | |
| Repearl SR 1350 - | 10 | 1.5 | 3 | 2.5 | 7 |
| Mitsubishi | | | | | |

CHART 4
Stain release results for stand alone repel agents in Downy

| | % by | | | Burned | |
|---|---|---|---|---|---|
| | weight in | | Min | motor | |
| Repel Agents | Downy | Mustard | oil | oil | Total |
| TG-580 - Daiken | 10 | 1.5 | 1.5 | 1 | 4 |
| TG-472 - Daiken | 10 | 1 | 1.5 | 1.5 | 4 |
| TG-581 - Daiken | 10 | 1.5 | 1 | 1 | 3.5 |
| Repearl F-357 - | 10 | 1.5 | 1 | 1 | 3.5 |
| Mitsubishi | | | | | |
| Repearl F-8095 - | 10 | 1.5 | 1 | 1 | 3.5 |
| Mitsubishi | | | | | |
| BK-96 - Mitsubishi | 10 | 1.5 | 1 | 1 | 3.5 |
| PM-930- 3M | 10 | 1 | 1 | 1 | 3 |

As can be seen by comparing the stain release data from Charts 3 and 4 to Chart 2 (taking into account the common stains and number of treatments between the charts), the combination of repel and release fluorochemicals has better stain release than either release agents alone or repel agents alone.

TABLE 5
Shows seconds until contact angle is zero
as a measure of repel performance

| | | Standard |
|---|---|---|
| | Average | Deviation |
| Control - 100% Downy Ultra (mountain spring ™) | 2.2 | 0.7 |
| in 1 L water | | |
| 0.3 g ZONYL 7713 in 1 L water | 0 | 0 |
| 0.3 g ZONYL 7713 + 3.1 g Downy in 1 L water | 42.2 | 33.0 |
| 0.3 g TG-992 (TG-992) in 1 L water | 0 | 0 |
| 0.3 g TG-992 + 3.1 g Downy in 1 L Water | 98.2 | 71.2 |
| 0.2 g ZONYL + 0.1 g TG-992(TG-992) in 1 L | 0 | 0 |
| water | | |
| 0.2 g ZONYL + 0.1 g TG-992 + 3.1 g Downy | 224.1 | 94.9 |
| in 1 L water | | |

Table 5 shows that repellency occurs at this concentration level only with the fluorochemical combined with a performance extender (in this case Downy) in the rinse cycle. These tests were run using as received Downy. Other quaternary ammonium compounds have been tested as performance extenders and give similar results (an example of this is the Adogen product line by Ashland Chemical Co.). Further reformulation of the fabric conditioner to exclude or adjust the amount of hydrophilic surfactants, such as alkoxylated fatty alcohols, would be expected to accentuate this repellency performance. The repel fluorochemical Zonyl and the release fluorochemical TG-992 each alone at this concentration do not have repellency to water when used in the rinse cycle. There is repellency when each fluorochemical is added to Downy in the rinse cycle, with the most repellency seen with both the repel and release fluorochemicals added with the fabric softener.

### Washing Effects on Repellency

Each compound or compound mixture was tested for efficacy based on number of treatments prior to staining or repelling. Sample nomenclature: the number following the sample represents the number of washes and treatments prior to staining. For example, the first wash, followed by treatment, is labeled with a X0, followed by X1, X2, and X3 which where washed and treated 1, 2, and 3 times, respectively, before staining. Each of the samples were added such that the repel and release chemistries equaled ˜10% by weight of the fabric softener.

CHART 6
Average number of seconds until water
reaches a contact angle of 0 degrees

| Sample | Average | Standard Deviation |
|---|---|---|
| Control 0 | 5.4 | 0.5 |
| Control 1 | 4.6 | 0.5 |
| Control 2 | 4.0 | 0.0 |
| Control 3 | 1.0 | 0.0 |
| Inv. A0 | 84.0 | 73.6 |
| Inv. A1 | 39.0 | 6.3 |
| Inv. A2 | 131.0 | 59.7 |
| Inv. A3 | 92.0 | 35.6 |
| Inv. C0 | 40.2 | 4.6 |
| Inv. C1 | 78.6 | 17.2 |
| Inv. C2 | 55.8 | 25.7 |
| Inv. C3 | 103.0 | 78.5 |
| Inv. D0 | 24.8 | 5.0 |
| Inv. D1 | 82.0 | 7.7 |
| Inv. D2 | 45.6 | 7.6 |
| Inv. D3 | 160.0 | 93.1 |
| Inv. E0 | 72.0 | 11.1 |
| Inv. E1 | 76.4 | 63.9 |
| Inv. E2 | 174.0 | 67.4 |
| Inv. E3 | 96.4 | 12.1 |
| Inv. H0 | 1.0 | 0.0 |
| Inv. H1 | 36.0 | 10.3 |
| Inv. H2 | 26.4 | 7.3 |
| Inv. H3 | 21.4 | 5.8 |

Chart 6 shows that as compared to control, the successive treatments demonstrate and increase in water repellency. This represents the samples ability not to absorb stains on immediate contact.

### Effect of Concentration of Repel and Release Chemistries

CHART 7
Seconds until water reaches a contact angle of
0 degrees based on weighted quantity of treatment
used (4% and 9% into fabric conditioner).

| | | Average | Standard Deviation |
|---|---|---|---|
| | Control 0 | 5.4 | 0.5 |
| | Control 1 | 4.6 | 0.5 |
| | Control 2 | 4.0 | 0.0 |
| | Control 3 | 1.0 | 0.0 |
| 9% | Inv. E0 | 72.0 | 11.1 |
| sample | Inv. E1 | 76.4 | 63.9 |
| | Inv. E2 | 174.0 | 67.4 |
| | Inv. E3 | 96.4 | 12.1 |
| 4% | Inv. E0 | 25.4 | 9.13 |
| sample | Inv. E1 | 52.8 | 22.39 |
| | Inv. E2 | 40.6 | 13.39 |
| | Inv. E3 | 93.4 | 40.56 |

As can be seen in Chart 7, a 4% by weight sample has less repellency as the 9% sample. Both sample levels, though, demonstrates that very small amounts of the fluorochemical chemistries can be added without significantly losing the effect, enabling a more inexpensive additive for home laundering.

### Buildup of Fluorochemicals

If fluorochemicals buildup on the fabric after multiple washings, the fabric becomes hydrophobic and does not allow proper moisture management making the garment very uncomfortable for the wearer (poor moisture transport and breathability). The Invention example E was added such that the amount of fluorochemicals equaled ˜9% by weight of fabric conditioner).

CHART 8
Seconds until water reaches a contact angle
of 0 degrees on 9% by weight samples

| | Average | Standard Deviation |
|---|---|---|
| Control 1 | 7.4 | 1.7 |
| Control 2 | 8.8 | 4.2 |
| Control 3 | 8.4 | 2.1 |
| Control 4 | 5.6 | 2.2 |
| Control 5 | 3.6 | 1.1 |
| Control 6 | 4.2 | 1.3 |
| Control 7 | 7.2 | 1.6 |
| Inv. E1 | 80.2 | 47.9 |
| Inv. E2 | 43.4 | 5.5 |
| Inv. E3 | 35.6 | 10.5 |
| Inv. E4 | 63.4 | 14.0 |
| Inv. E5 | 67.2 | 24.3 |
| Inv. E6 | 45 | 20.0 |
| Inv. E7 | 66.6 | 30.4 |
| Inv. E8 | 74.6 | 30.5 |

As can be seen from Chart 8, there is no significant buildup of fluorochemicals on the fabric after multiple washings. This would suggest that the treatment is non-durable and a consistent performance can be realized. This level of repellency is much less than mill treated garments, and provides enough repellency to repel small amounts of liquid contact.

CHART 9
Stain release results non-fluorinated agents

| | | | | Food/Dirt | Min | Corn | | Oil | |
|---|---|---|---|---|---|---|---|---|---|
| | Ketchup | Mustard | Dirt | Total | oil | oil | BMO | Total | Total |
| Control cotton | 2.5 | 1.5 | 2.0 | 6.0 | 3.5 | 3.0 | 2.5 | 9.0 | 15 |
| EAF1540 | 2.5 | 2.0 | 2.5 | 7.0 | 3.0 | 3.0 | 3.0 | 9.0 | 16 |
| Diethyl Malonate/ | 3.5 | 2.0 | 4.0 | 9.5 | 4.0 | 3.5 | 3.0 | 10.5 | 20 |
| EAF1540 | | | | | | | | | |
| Diethyl Malonate/ | 4.5 | 2.0 | 3.5 | 9.5 | 4.0 | 3.5 | 3.0 | 10.5 | 20 |
| EAF1540/Adogen | | | | | | | | | |
| Quat | | | | | | | | | |
| Control Polyester | 3.0 | 4.0 | 1.0 | 8.0 | 2.0 | 2.0 | 1.0 | 5.0 | 13 |
| Amine-G-LC on | 4.0 | 4.0 | 3.0 | 11.0 | 3.5 | 4.0 | 3.0 | 10.5 | 21.5 |
| polyester | | | | | | | | | |

The new compositions give the textile a better release profile when compared to the control systems. The new compositions are also more efficient than the siloxane alone. Chemical EAF-1540 available from Wacker Chemie and Amine G is available from Lambert.

CHART 10
Seconds until contact angle of water is zero

| | Silicone | Water |
|---|---|---|
| | Deposition | Wicking time |
| | (X-ray counts) | (Seconds) |
| Downy Control | 5884 | 18 |
| EAF 1540 | 15779 | 68.4 |
| 60% EAF 1540/40% Adogen Quat | 9320 | 101.4 |
| 60% Diethyl Malonate/40% EAF1540 | 13158 | 148.4 |
| 60% (2 parts Diethyl Malonate/ | 10747 | 277 |
| 1 part EAF1540)/40% Adogen Quat | | |

The data shows that the addition of the quat. greatly enhances water repellency on all samples. It was also observed that the siloxane is deposited on the fabric. As can be observed the repellency is independent of the amount of siloxane deposited on the fabric in the presence of the enhancer (in this case the Adogen quat.)

The invention has been described in detail with particular reference to certain preferred embodiments thereof, but it will be understood that variations and modifications can be effected within the spirit and scope of the invention.

What is claimed is:

1. A stain release and repellant fabric conditioner comprising a repel type fluorochemical, a release type fluorochemical, and a performance extender.

2. The stain release and repellant fabric conditioner of claim 1, wherein the repel type fluorochemical is selected from the group consisting of fluorinated acrylates, fluorinated urethanes, and fluorinated dendrimers.

3. The stain release and repellant fabric conditioner of claim 1, wherein the release type fluorochemical is a hybrid dual function fluoropolymer or C4 type fluoropolymer.

4. The stain release and repellant fabric conditioner of claim 1, wherein the performance extender is a quaternary ammonium compound.

5. The stain release and repellant fabric conditioner of claim 1, wherein the repel type fluorochemical and the release type fluorochemical have melting temperatures of between 25 and 100 degrees Celsius.

6. The process of applying soil release fabric conditioner comprising:
washing fabric with a detergent and water;
adding the stain release and repellant fabric conditioner of claim 1 to a rinse cycle; and,
removing the water from the fabric.

7. The process of claim 6, wherein the fabric conditioner is added in an amount such that the release type and repel type fluorochemicals are greater than 0.03% by weight of the fabric.

8. The process of claim 6, wherein the fabric conditioner is added in an amount such that the release type and repel type fluorochemicals are between 0.06 and 2.0% by weight of the fabric.

9. The process of claim 6, wherein the fabric conditioner is added in an amount such that the release type and repel type fluorochemicals are between 0.35 and 0.65% by weight of the fabric.

10. The process of claim 6, wherein the rinse cycle has a temperature of at least 15 degree Celsius.

11. A stain release and repellant fabric conditioner comprising a propoxylated hydroxyl- or amino-polysiloxane and a performance extender.

12. The stain release and repellant fabric conditioner of claim 11, wherein the performance extender is a quaternary ammonium compound.

13. The stain release and repellant fabric conditioner of claim 11, wherein the propoxylated hydroxyl- or amino-polysiloxane comprises an amino siloxane reacted with a fatty chain and a performance extender.

14. The stain release and repellant fabric conditioner of claim 13, wherein the fatty chain is selected from the group consisting of lauryol, stearoyl, or tallowoyl.

15. The process of applying soil release fabric conditioner comprising:
washing fabric with a detergent and water;
adding the stain release and repellant fabric conditioner of claim 11 to a rinse cycle; and,
removing the water from the fabric.

16. The process of claim 15, wherein the fabric conditioner is added in an amount such that the polysiloxane is between 6 and 8% by weight of the extender.

17. A stain release and repellant fabric conditioner comprising a repel type fluorochemical and a performance extender.

18. A stain release and repellant fabric conditioner comprising a release type fluorochemical and a performance extender.

19. A fabric treated with the stain release and repellant fabric conditioner of claim 1.

20. A fabric treated with the stain release and repellant fabric conditioner of claim 11.
